(19) United States
(12) Patent Application Publication
(10) Pub. No.: US 2018/0060778 A1
(43) Pub. Date: Mar. 1, 2018

(54) DRIVER LOCATION PREDICTION FOR A TRANSPORTATION SERVICE

(71) Applicant: Uber Technologies, Inc., San Francisco, CA (US)

(72) Inventors: Danhua Guo, San Mateo, CA (US); John Mark Nickels, Tiburon, CA (US); Eoin Daniel O'Mahony, San Francisco, CA (US); Benjamin Kaplan, San Francisco, CA (US); Chaoxu Tong, Oakland, CA (US); Thi Duong Nguyen, San Francisco, CA (US)

(21) Appl. No.: 15/252,571

(22) Filed: Aug. 31, 2016

(51) Int. Cl. G06Q 10/06; G01C 21/34; G01C 21/36

(52) U.S. Cl. CPC G06Q 10/06315; G06Q 10/063114; G01C 21/3667; G01C 21/343

(57) ABSTRACT

A transport facilitation system can receive current location data from driver devices of drivers operating throughout a given region. The system can further receive a pick-up request from a user device of a requesting user within the given region, the pick-up request including pick-up location data. The system can determine a plurality of candidate drivers to service the pick-up request based, at least in part, on the pick-up location data and current location data of the candidate drivers. The system can predict a future location for each of the candidate drivers and select a first driver from the candidate drivers to service the pick-up request based on the predicted future locations. The system may then transmit a transport invitation to the first driver to service the pick-up request.

### BACKGROUND

Traditional transport services typically select drivers to service transportation requests based on straight line distances. More recently, driver selections have been made using road surface distance and/or traffic data to select drivers based on an estimated time of arrival (ETA) to the pick-up location. Thus, transportation services have moved from pure distance selections to time-based selections in order to improve service flows in a given region. However, even utilizing time-based selections, the transport service entity may not be fully optimizing the utility of the driver supply and rider demand marketplace.

Given a pick-up location, certain available drivers operating proximate to the pick-up location may have higher ETAs and/or actual time of arrivals due to traffic conditions, one-way streets, traffic flows, lane positioning, and driver awareness. In some cases, even drivers having a shortest calculated ETA may inadvertently prolong the actual arrival time by, for example, missing a turn or taking a wrong turn (e.g., due to the driver's movement while ETA calculations are being made). Thus, using a purely time-based and/or location-based driver selection process, the service entity cannot fully prevent undesirable occurrences that effectively prolong ETAs and impair the overall service experience for both requesting rider and driver.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example transport facilitation system in communication with user and driver devices, in accordance with examples described herein;

FIG. 2 is a block diagram illustrating an example driver location prediction engine utilized in connection with a transport facilitation system, according to examples described herein;

FIG. 3 is a flow chart describing an example method of location prediction of drivers to optimize driver selection, according to examples described herein;

FIG. 4A is a block diagram illustrating an example rider device executing a designated rider application for a transport arrangement service, as described herein;

FIG. 4B is an example screenshot illustrating a transport service type selection and request screen on a rider device, according to examples described herein;

FIG. 5 is a block diagram illustrating an example driver device executing a designated driver application for a transport arrangement service, as described herein; and

FIG. 6 is a block diagram illustrating a computer system upon which examples described herein may be implemented.

### DETAILED DESCRIPTION

A transport facilitation system is provided herein that manages an on-demand transportation arrangement service linking available drivers and/or autonomous vehicles (AVs) with requesting riders throughout a given region (e.g., a metroplex such as the San Francisco Bay Area). In doing so, the transport facilitation system (or “transport system”) can receive user requests for transportation (or requests for delivery services) from requesting users via a designated rider application executing on the users' mobile computing devices. Based on an inputted pick-up location, the transport system can identify a number of proximate available vehicles and transmit a transport invitation to one or more driver devices of the proximate available vehicles to service the pick-up request. In many examples, the drivers can either accept the invitation or decline the invitation based on a variety of factors, for example, if the driver wants to stop driving for the day, or if the route to pick up the rider is too long or having a pick-up location that is impractical for the driver.

In determining a most optimal driver to service a given pick-up request, the transport system can identify a plurality of candidate drivers to service the pick-up request based, at least in part, on a pick-up location indicated in the pick-up request. For example, the transport system can determine a region based on a radius from the pick-up location or a geo-fence surrounding the pick-up location, and identify a set of candidate drivers (e.g., twenty or thirty drivers within the region or the geo-fence). For each of the candidate drivers, the transport system can predict a future location of the driver when performing a driver selection process in response to a given pick-up request. The transport system may then perform operations, such as providing improved ETA data to rider devices based on the predicted future locations, for example, and select an optimal driver from the candidate set to service the pick-up request based on the predicted future locations.

According to some examples, in predicting the future location of a candidate driver, the transport system can determine a direction of travel and speed of the respective candidate driver utilizing the location-based resources of the driver device (e.g., a mobile computing device executing a driver application specific to the transportation arrangement service), and project or otherwise predict the future location (e.g., ten or twenty seconds into the future) of the respective candidate driver based on the direction of travel and speed. In certain examples, the transport system can initially determine whether the destination of the driver is known, and if so, project a future location for the driver along the driver's current route to the known destination.

In some examples, for drivers with unknown destinations, the transport system can utilize road network data to determine a number of possible routes and/or turns that the driver can take, and calculate a probability that the driver will take each potential route. In some examples, the transport system can compile historical driver data indicating typical routes traveled by the candidate driver, and/or compile historical driver data indicating typical routes traveled by a group of drivers. Additionally or alternatively, the transport system can access or compile traffic flow data indicating the overall traffic flows over the multiple route options. In certain examples, the location-based data can indicate a certain part of the road in which the candidate driver is driving, and can thus indicate an actual path of travel that the driver will take in the immediate future. In variations, the transport system can implement a shadow mode via the driver application on driver devices operating throughout the given region in order to compile traffic flow data to establish and bolster the accuracy of predicted location probability calculations. In this mode, the transport system can continually make location predictions of drivers and readily test the results as driver travel throughout the given region to increase prediction accuracy.

According to many implementations, the transport system can be triggered to make location predictions of driver in response to receiving a pick-up request comprising a pick-up location for a requesting rider. For each candidate driver, the transport system can make probability determinations of a future location of the driver at a predetermined time (e.g., which can correspond to a delay or typical lag time—approximately twenty seconds—between when the transport system makes a traditional driver selection and when the driver inputs a confirmation to accept an invitation to service the pick-up request). In some examples, the delay may be a result of network bandwidth constraints, the amount of time to perform the driver selection process, and/or the amount of time the driver takes in order to decide whether or not to accept the invitation. Thus, instead of utilizing the driver's current locations to make a driver selection, the transport system can utilize the driver's most probable future location.

Among other benefits, the examples described herein achieve a technical effect of improving upon current ETA calculations and driver selections by predicting the future location of candidate drivers (e.g., fifteen to twenty seconds into the future) for any given pick-up request. Such predicted locations can also contribute to improved driver selections for requested rides, and reduce driver and rider cancellations.

As used herein, a computing device refers to devices corresponding to desktop computers, cellular devices or smartphones, personal digital assistants (PDAs), laptop computers, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Some examples are referenced herein in context of an autonomous vehicle (AV) or self-driving vehicle (SDV). An AV or SDV refers to any vehicle which is operated in a state of automation with respect to steering and propulsion. Different levels of autonomy may exist with respect to AVs. For example, some vehicles may enable automation in limited scenarios, such as on highways, provided that drivers are present in the vehicle. More advanced AVs can drive without any human assistance from within or external to the vehicle. Such vehicles are often required to make advanced determinations regarding how the vehicle behaves given challenging surroundings of the vehicle environment.

System Descriptions

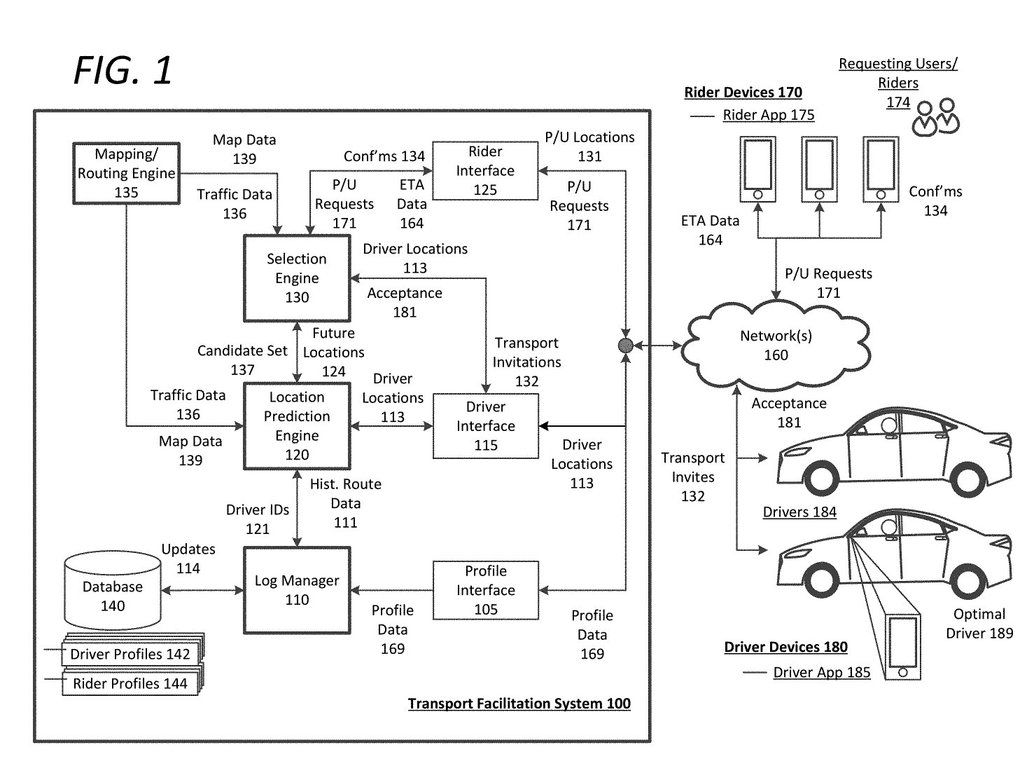

FIG. 1 is a block diagram illustrating an example transport facilitation system in communication with user and driver devices, in accordance with examples described herein. The transport facilitation system 100 can manage a transportation arrangement service that connects requesting users or riders 174 with drivers 184 that are available to service the users' 174 pick-up requests 171. The transportation arrangement service can provide a platform that enables ride-sharing services between requesting users 174 and available drivers 184 by way of a rider application 175 executing on the rider devices 170, and a driver application 185 executing on the driver devices 180. As used herein, a rider device 170 and a driver device 180 can comprise a computing device with functionality to execute a designated application corresponding to the transportation arrangement service managed by the transport facilitation system 100. In many examples, the rider device 170 and the driver device 180 can comprise mobile computing devices, such as smartphones, tablet computers, VR or AR headsets, on-board computing systems of vehicles, and the like. Example transportation arrangement services implementing a ride sharing platform include those provided by UBER Technologies, Inc. of San Francisco, Calif.

The transport facilitation system 100 can include a rider interface 125 to communicate with rider devices 170 over one or more networks 160 via a rider application 175. According to examples, a requesting user 174 wishing to utilize the transportation arrangement service can launch the rider application 175 and transmit a pick-up request 171 over the network 160 to the transport facilitation system 100. In certain implementations, the requesting rider 174 can view multiple different service types managed by the transport facilitation system 100, such as ride-pooling, a basic ride share service type, a luxury vehicle service type, a van or large vehicle service type, a professional driver service (e.g., where the driver is certified), and the like. The transport facilitation system 100 can utilize the driver locations 113 to provide the rider devices 170 with ETA data 164 of proximate drivers for each respective service. For example, the rider application 175 can enable the user 174 to scroll through each service type. For example, in response to a soft selection of a particular service type, the transport facilitation system 100 can provide ETA data 164 on a user interface of the rider app 175 that indicates an ETA of the closest vehicle for the service type, and/or the locations of all proximate available vehicles for that service type. As the user scrolls through each service type, the user interface can update to just show visual representation of vehicles for that service type on a map centered around the user 174 or a pick-up location set by the user. The user can interact with the user interface of the rider app 175 to select a particular service type, and transmit a pick-up request 171.

In some examples, the pick-up request 171 can include a pick-up location within a given region (e.g., a metropolitan area managed by one or more datacenters corresponding to the transport facilitation system 100) in which a matched driver is to rendezvous with the requesting user 174. The pick-up location can be inputted by the user by setting a location pin on a user interface of the rider app 175, or can be determined by a current location of the requesting user 174 (e.g., utilizing location-based resources of the rider device 170). Additionally, the requesting user 174 can further input a destination during or after submitting the pick-up request 171.

In various implementations, the transport facilitation system 100 can further include a selection engine 130 to process the pick-up requests 171 in order to ultimately select drivers 184 to service the pick-up requests 171. The transport facilitation system 100 can include a driver interface 115 to communicate with the driver devices 180 via the driver application 185. In accordance with various examples, the driver devices 180 can transmit their current locations using location-based resources of the driver devices 180 (e.g., GPS resources). These driver locations 113 can be utilized by the selection engine 130 to identify a set of candidate drivers 184, in relation to the pick-up location, that can service the pick-up request 171. The candidate drivers 184 can each have a driver state in which he/she is available to provide transport services (e.g., is online and/or capable of picking up another rider). In some examples, transport facilitation system 100 can further select the candidate set of drivers 184 based on the respective destinations of those candidate drivers. For example, the transport facilitation system 100 can identify a particular driver that is currently servicing a pick-up request 171, but can be rerouted to make a pick-up along the way (e.g., for ride-pooling examples). Additionally or alternatively, the transport facilitation system 100 can also filter a set of proximate drivers in relation to the pick-up location based on a specifically requested vehicle type by the requesting rider 174 to identify the set of candidate drivers 184.

In certain implementations, the transport facilitation system 100 can ultimately select a proximate self-driving vehicle (SDV) to service the pick-up request 171, as described below. Thus, the pool of proximate candidate drivers in relation to a pick-up location can also include one or more SDVs operating throughout the given region. Furthermore, in some aspects, the transport facilitation system 100 can include a mapping and/or routing engine 135, or can utilize a third-party mapping service, to generate map data 139 and or traffic data 136 in the environment surrounding the pick-up location. The map data 139 and/or traffic data 136 can be utilized by the selection engine 130 to ultimately make a driver selection for a given pick-up request 171. In still further implementations, the transport facilitation system 100 can include a log manager 110 and a profile interface 105 to receive profile data 169 from any of the drivers 184 and riders 174 in the given region. For example, in one implementation, the profile data 169 can comprise information indicating routines and/or preferences of the drivers 184 and/or riders 174 (e.g., such as routines or preferences specified by drivers and/or riders, or determined based on historical data of past actions or trip requests. Such routines and preferences can be respectively stored and managed in driver profiles 142 and rider profiles 144 of the database 140. As provided herein, the profile data 169 may be inputted by the riders 174 and drivers 184, or can be learned by the transport facilitation system over time.

According to examples, the driver profiles 142 can include data indicating acceptance parameters characteristic of that particular driver. For example, over time, a driver may have a higher propensity of accepting transport invitations 132 within a certain neighborhood, or transport invitations 132 corresponding to trips having longer travel times. Conversely, the driver profile 142 can further indicate the refusal or rejection parameters for that driver. For example, the driver may have a propensity towards rejecting transport invitations 132 for rides from the airport or ones that involve congested freeways. Furthermore, the driver profiles 142 can include preferred or routine routes traveled by the corresponding driver 184. Such routine information can provide valuable data for determining a future location of the driver 184, as described below.

In addition, the rider profiles 144 may indicate certain preferences or routines of the requesting rider 174. For example, the rider profile 144 may further indicate whether the rider prefers a certain vehicle type or size. As provided herein, the selection engine 130 may access the driver profiles 142 of a candidate set of drivers 137 and the rider profile 144 of a rider associated with a particular pick-up request 171, in order to ultimately make a driver selection.

In certain implementations, the transport facilitation system 100 can include a location prediction engine 120 which can, for example, improve the ETA data 164 transmitted to the rider devices 170. The location prediction engine 120 may also provide the future locations 124 of each of the candidate set of drivers 137 to the selection engine 130 to facilitate in a more optimal selection process. In certain variations, the location prediction engine 120 can provide the future locations 124 to the mapping engine 135, which can in turn project the future locations 124 onto the map data 139 for use by the selection engine 130 in providing improved ETA data 164 to the rider devices 170 and/or making a driver selection to service a given pick-up request 171.

In predicting the future locations 124 of the drivers, the location prediction engine 120 can receive the driver locations 113 from the location-based resources of the driver devices 180. Based on the driver locations 113, the location prediction engine 120 can determine a speed and direction of travel for each of the drivers 184 operating throughout the given region. For example, the location prediction engine 120 can initially receive a candidate set of drivers 137 from the selection engine 130 based on a pick-up location 131 indicated in the pick-up request 171. In some examples, the mapping/routing engine 135 can provide the location prediction engine 120 with map data 139 and/or traffic data 136 indicating the current routes being traveled by drivers having known destinations, or indicating all possible routes of drivers with unknown destinations.

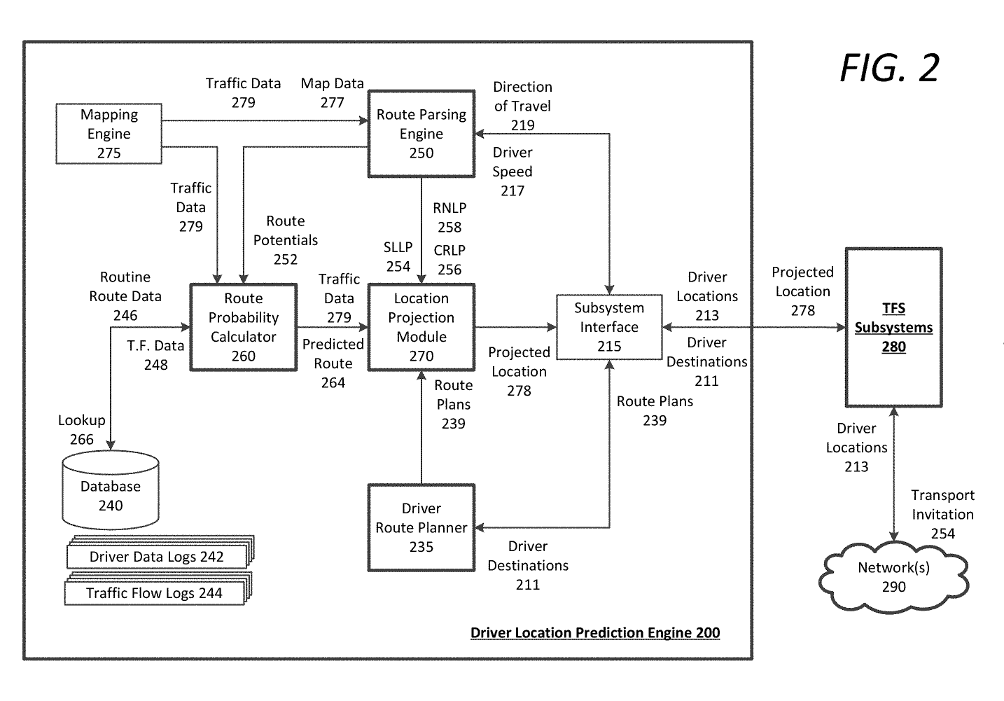

The location prediction engine 120 can utilize the map data 139 and/or traffic data 136 to calculate probabilities that a particular driver in the candidate set 137 will travel along one potential route versus one or more other potential routes. In calculating the probabilities per potential route, the location prediction engine 120 can provide driver identifiers 121 for each of the candidate drivers to the log manager 110 of the transport facilitation system 100. The log manager 110 can utilize the driver identifiers 121 to look up historical route data 111 for those drivers in their driver profiles 142 to determine whether the driver follows a particular routine, or travels along routine paths. In various examples, the location prediction engine 120 can further analyze typical traffic flows throughout the given region in calculating the route probabilities. Once the probabilities for each potential route are calculated, the location prediction engine 120 can project a future location 124 of the driver onto the map data 139. As provided herein, the future locations 124 may then be provided to the selection engine 130 and/or mapping/routing engine 135 in order to improve the ETA data 164 and the overall selection process. A more detailed description of the location prediction engine 120 is provided below with respect to FIG. 2.

According to various examples, the selection engine 130 can utilize the future locations 124 of each of the candidate set of drivers 137 to select an optimal driver 189 to service the pick-up request 171. In some examples, the selection engine 130 can select the optimal driver 189 based on the optimal driver's 189 current distance and/or time to the pick-up location 131. In variations described herein, the selection engine 130 can select the optimal driver 189 based on the optimal driver's 189 future location 124 as determined by the location prediction engine 120. Upon selecting the optimal driver 189, the selection engine 130 can generate and transmit a transport invitation 132 for the optimal driver 189, which the optimal driver 189 can accept or reject. In accepting the transport invitation 132, the driver 189 can input an acceptance 181 into the driver app 185, which can be transmitted to the driver interface 115 over the network 160. The selection engine 130 can process the acceptance 181 by generating a confirmation 134 indicating certain vehicle information (e.g., vehicle identifiers such as type, color, and license plate information, the driver's name, a driver photo, and the like). The selection engine 130 may then transmit the confirmation 134 to the requesting user's 174 rider device 170, which can be viewable by the requesting user 174 on the rider app 175. Furthermore, the selection engine 130 can generate the confirmation 134 to include the ETA data 164 of the selected driver 189 as the driver is en route (e.g., traveling) to rendezvous with the requesting user 174 at the pick-up location 131.

FIG. 2 is a block diagram illustrating an example driver location prediction engine utilized in connection with a transport facilitation system (TFS), according to examples described herein. The below description of FIG. 2 may incorporate the functions of one or more logical blocks described with respect to FIG. 1. Furthermore, one or more components or logical blocks of the driver location prediction engine 200 as shown and described with respect to FIG. 2, may be connected to and/or incorporated with one or more of the TFS subsystems 280, as described in connection with FIG. 1, and as illustrated in FIG. 2. For example, the TFS subsystems 280 can include one or more components described with respect to the transport facilitation system as shown and described with respect to FIG. 1.

Referring to FIG. 2, the driver location prediction engine 200 can include a subsystem interface 215 to receive driver locations 213 from the TFS subsystems 280. The driver locations 213 can be received periodically (e.g., once every three to four seconds) or as a continuous stream, and can indicate a direction of travel 219 and a speed of the driver 217. For example, the driver location prediction engine 200 can include a route parsing engine 250, which can receive map data from a mapping engine 275. In an initial stage (V0), the route parsing engine 250 can utilize the direction of travel 219 and driver speed 217 to identify a straight line location point 254 of the driver on the map data 277 based on a straight line or Haversine calculation at a future time t, in light of the driver speed 217. As provided herein, t can comprise a typical lag time in the system that corresponds to the traditional time delta for previous embodiments of transport facilitation systems (i) making a driver selection, (ii) generating and transmitted a transport invitation 254, and (iii) the selected driver accepting the resultant transport invitation (e.g., ˜twenty seconds). The route parsing engine 250 can submit the straight line location point 254 to a location projection module 270, which can generate the projected future location 278 of the driver onto the map data 277. As provided herein, the straight line calculation utilizing the straight line location point 254 can comprise a final fall back option (V0) in a hierarchical fall back procedure implemented by the driver location prediction engine 200.

In a secondary stage (V1), the route parsing engine 250 can utilize the map data 277 to identify a road on which the driver is operating, and calculate a current road location point 256 for the driver at the future time t. In doing so, the route parsing engine 250 can account for road curvatures of the current road being traveled by the driver. Thus, instead of a pure straight line or Haversine projection onto map data 277 (V0), the route parsing engine 250 can utilize the driver speed 217 and the direction of travel 219 to calculate the current road location point 256 at the future time t. The route parsing engine 250 can then submit the current road location point 256 to the location projection module 270, which can project the current road location point 256 onto the map data 277. This current road location point 256 can comprise another fall back option (V1) in the hierarchical fall back procedure, described in detail below.

According to a third stage analysis (V2), the driver location prediction engine 200 can include a driver route planner 235 that can receive driver destinations 211 (e.g., after a driver is selected to service a pick-up request), and provide route plans 239 for the driver to follow to the destination. In this V2 stage, the driver route planner 235 can provide the route plan 239 directly to the location projection module 270, which can utilize traffic data 279 and/or the driver speed 217 to project a location 278 of the driver at the future time t onto the map data 277. This additional analysis is conditional upon the driver destination 211 being known. Thus, this additional analysis can occur independently of any other stage, and can be triggered whenever a candidate driver's destination is known.

In a fourth stage (V3), the route parsing engine 250 can utilize the map data 277 to analyze the road network in the forward operational direction of the driver's current location 213. In many scenarios, the road network information in the map data 277 can indicate a single option path that the driver will travel (e.g., including one or more turns or roads). The route parsing engine 250 can utilize the driver speed 217 to calculate a road network location point 258 on the map data 277 indicating a future location of the driver at time t in the future. The route parsing engine 250 can submit the road network location point 258 to the location projection module 270, which can project the road network location point 258 onto the map data 277 as the future location 278 of the driver at time t. In variations, the route parsing engine 250 can further utilize traffic data 279 to more accurately determine the road network location point 258.

In a final stage (V4), the route parsing engine 250 can combine the direction of travel 219, the driver speed 217, traffic data 279, and/or the map data 277 to identify a set of route potentials 252 that the driver can take within time t. In certain implementations, the map data 277 can indicate road segment information, such as a road segment speed profile. Accordingly, in addition to the driver speed 217, the location projection module 270 can also utilize the road segment speed profile to ultimately predict the future location 278 of the driver. Thus, the location projection module 270 can determine whether the driver is going to speed up (e.g., when the driver is currently stopped at a red light), or slow down (e.g., when the driver is approaching a stop sign), in order to more accurately predict the driver's further location 278. While the route potentials 252 can include any number of routes, since the typical lag time t is only on the order of fifteen to twenty seconds, in some examples, the route potentials 252 may be limited to a maximum of three or four potential routes. According to this example, the driver location prediction engine 200 can include a route probability calculator 260, which can receive the route potentials 252 from the route parsing engine 250 and can calculate a probability for each route potential that the driver will travel along that route.

In calculating the route probabilities, the route probability calculator 260 can access a local database 240 that can include traffic flow logs 244 indicating typical route flows of all vehicles operating throughout the given region. The route probability calculator 260 can utilize the route potentials 252 to perform a lookup 266 in the traffic flow logs 244 for traffic flow data 248 corresponding to each of the route potentials 252. In some scenarios, the traffic flow data 248 can indicate that the vast majority of vehicles (e.g., 70%) travel along a primary route in comparison to a secondary route. The route probability calculator 260 can directly utilize the traffic flow data 248 to determine a most probable predicted route 264 for the driver at time t in the future. In some aspects, the route probability calculator 260 can calculate a weighted average of predicted or possible routes in order to determine the predicted route 264.

Additionally or alternatively, in this final stage (V4), the route probability calculator 260 can access driver data logs 242 in the database 240 to determine whether the candidate driver typically follows a routine route 246. For example, it is contemplated that many drivers of the transportation arrangement service travel along routine paths when they are available to service pick-up requests. Such routines may be previously identified by the transport system and the routine routes 246 may be logged into a driver data log 242 specific to that particular driver. Thus, the route probability calculator 260 can not only identify universal traffic flow data 248 in determining the most probable predicted route 264, the route probability calculator 260 can further utilize routine route data 246 logged in the candidate driver's data log 242 to converge on a most probable predicted route 264. The route probability calculator 260 can then submit the predicted route 264 to the location projection module 270, which can project the future location 278 of the driver on the most probable route 264 at time t in the future.

According to examples described herein, each of the stages (V0, V1, V2, V3, and V4) can be executed in accordance with prioritizations by the location projection module 270 to determine a most accurate future location of the driver at time t in the future. For example, the location projection module 270 can implement a hierarchical fall back process prioritizing V4, then V3, then V2, then V1, and finally V0. Thus, the location projection module 270 can prioritize the V4 calculation as the projected location 278 of the driver at time t in the future, and can submit the projected V4 location 278 to the TFS subsystems 280 accordingly. The TFS subsystems 280 may then utilize the projected future location 278 for ETA calculations, driver selections, and the like.

If in V4, the route probability calculator 260 cannot determine a most probable route 264 (e.g., due to equal probabilities), then the location projection module 270 can fall back to V3, and utilize the road network location point 258 from the route parsing engine 250 to project the future location 278 of the driver in light of the road network information in the map data 277 and/or traffic data 279. The location projection module 270 can then submit the projected future location 278 of the candidate driver to the TFS subsystems 280 accordingly.

If the route parsing engine 250 is unable to determine a road network location point 258 (e.g., due to multiple possible paths of travel), then the location projection module 270 can fall back to V2 and determine whether the destination of the driver 211 is known. If so, then the location projection module 270 can utilize the V2 route plan 239 of the driver to project the predicted location of the driver 278 at time t based on the known driver destination 211, and submit the projected future location 278 to the TFS subsystems 280 accordingly. If the destination 211 is not known, then the location projection module 270 can fall back to V1—utilizing the current road location point 256 from the route parsing engine 250 to project the future location 278 of the driver onto a current road being traveled by the driver, and submitting the projected location 278 to the TFS subsystems 280 accordingly. If, however, the current road that the candidate driver is traveling is unknown, then the location projection module 270 can fall back to V0, and utilize the straight line location point 254 for the candidate driver to project the future location at time t in the future. Finally, if for some reason the driver speed 217 and direction of travel 219 is unknown, then the TFS subsystems 280 can fall back completely to the driver's current location.

In the above examples, the driver location prediction engine 200 can provide a projected future location 278 for each candidate driver in any candidate driver set for a respective pick-up request. Additionally or alternatively, ETA data provided to rider devices—for soft selections of service types as well as for inputted pick-up requests—can be based on the projected locations 278 submitted by the driver location prediction engine 200. The projected location 278 can provide the TFS subsystems 280 with vital data that can aid in the driver selection process to ensure that drivers are given sufficient notice to take expected routes to pick-up locations. In effect, utilization of the projected locations 278 can further result in lower actual times of arrival (e.g., since a reduction in missed or wrong turns by the driver is essentially assured), and more accurate ETAs provided to the rider—decreasing driver rejection and cancellation rates, and decreasing rider cancellation rates.

Methodology

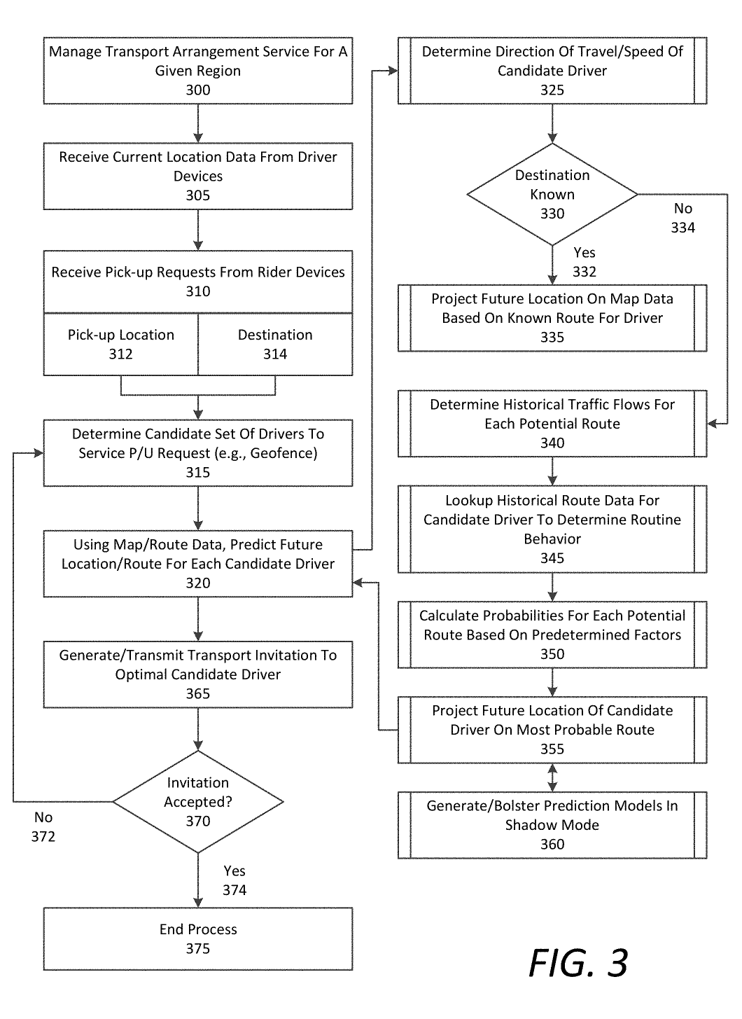

FIG. 3 is a flow chart describing an example method of location prediction of drivers to optimize driver selection, according to examples described herein. In the below discussion of the FIG. 3, reference may be made to reference characters representing like features as shown and described with respect to FIGS. 1 and 2. Furthermore, the process described with respect to FIG. 3 may be performed by an example transport facilitation system 100 implementing a driver location prediction engine 200 as shown and described with respect to FIGS. 1 and 2. As provided herein, the steps as shown in FIG. 3 are included for illustrative purposes. As such, the transport facilitation system 100 may perform some or all of the steps as shown in FIG. 3. Along these lines, one or more steps shown in FIG. 3 may be omitted from the method as performed by the transport facilitation system 100. Referring to FIG. 3, the transport facilitation system 100 can manage a transportation arrangement service that links requesting riders 174 with available drivers 184 in a given region (300). In doing so, the transport facilitation system 100 can receive the current locations of drivers 184 operating throughout the given region from the location-based resources of the driver devices 180 (305). In certain implementations, the transport facilitation system 100 can further receive the locations of SDVs operating to service pick-up requests 171 throughout the given region, and can also predict SDV locations as well as driver locations, as described with respect to driver location prediction herein.

In various implementations, the transport facilitation system 100 can receive pick-up requests 171 for the rider devices 170 (310). The pick-up requests 171 can specify a pick-up location (312), and can further specify a destination location (314). According to examples described herein, the transport facilitation system 100 can then determine a candidate set of drivers to service the pick-up request 171 (e.g., by setting a geo-fence centered on the pick-up location) (315). Using map data, route data, and/or historical data, the transport facilitation system 100 can predict a future location 124 and/or route for the driver at a time t in the future (e.g., ˜twenty seconds) for each candidate driver (320).

It is contemplated that in comparing multiple regions, the behavioral characteristics of drivers may vary and can reveal certain common traits. According to examples described herein, the time t can represent a combined time it takes for the transport facilitation system 100 to transmit an transport invitation 132 to the driver app 185, the driver app 185 to process and display the transport invitation 132 to the driver 184, the driver reaction time to decide whether to accept the transport invitation 132 or not, and for the driver app 185 to send the response back to the transport facilitation system 100. In some regions, the average driver response time to a transport invitation 132 may be different from other regions. In variations, the network infrastructure of certain regions may cause delayed transmissions as compared to other regions. Accordingly, the transport facilitation system 100 can determine or otherwise establish the time t to be region-specific based on these variable factors inherent to the region.

In determining the future locations 124, the transport facilitation system 100 can determine one or more of a direction of travel, a speed of the candidate driver (325), and/or a road segment speed profile on which the candidate driver is driving. In certain examples, the transport facilitation system 100 can utilize the road segment's speed profile instead of, or as a supplement to, the speed of the candidate driver. In one example, if the driver is operating on a one way street, the transport facilitation system 100 may predict the future location of the driver with on the current location of the driver and the speed profile of the road segment (e.g., a speed limit or observed average speed based on historical data). The transport facilitation system 100 can further determine whether the destination of the driver is known (330). If the destination of the driver is known (332), then the transport facilitation system 100 can project the future location 124 of the candidate driver onto map data based on the known route on which the driver is traveling (335). However, if the destination is not known (334), then the transport facilitation system 100 can determine historical traffic flows in a forward operational direction of the driver, and for each potential route that the driver can choose (340). In certain implementations, the transport facilitation system 100 can further look up historical route data for the candidate driver to determine routine driver behavior indicating common routes traveled by the candidate driver (345).

The transport facilitation system 100 can then calculate a probability, for each potential route, that the driver will take that route (350). The transport facilitation system 100 can then project the future location 124 of the driver onto the most probable route (355). As provided herein, the projection of the prediction location 124 can be based on the driver's current speed, direction of travel, and/or current traffic data to most accurately set the future location of the driver. In certain implementations, the transport facilitation system 100 can construct, test, and/or bolster the accuracy of location prediction models by using driver locations and routes untriggered by a pick-up request 171, as the drivers operate throughout the given region (360). In doing so, the transport facilitation system 100 can implement a background shadow mode on driver devices to make backend probability calculations and location predictions as drivers operate throughout the given region. As vast amounts of data are collected and the tally of probability calculations expands dramatically, the accuracy of such calculations can be bolstered significantly, enabling the transport facilitation system 100 to develop better prediction models and hence improved ETA information, improved driver selections, and lower cancellation rates. Thus, the transport facilitation system 100 can utilize the constructed location prediction models that are dynamically tested and improved via execution of the shadow mode instructions on the driver devices.

According to examples herein, based on the predicted future locations 124 of the candidate drivers, the transport facilitation system 100 can generate and transmit a transport invitation 132 to a most optimal driver 189 (365). It is contemplated that the location prediction engine 120, 200 can be implemented with a location-based (current or future) or time-based driver selection engine 130 of the transport facilitation system 100. Thus, in these implementations, the optimal driver 189 can be a closest driver based on the predicted future location 124, or a shortest ETA driver based on the predicted future location 124. The transport facilitation system 100 can then determine whether the driver accepts the transport invitation 132 (370). If the driver does accept (374), then the location prediction process may end (375). However, if the driver rejects the transport invitation 132 (372), then the transport facilitation system 100 can repeat the process by determining a new candidate set of drivers for the pick-up request 171 (315).

Rider/Driver Devices

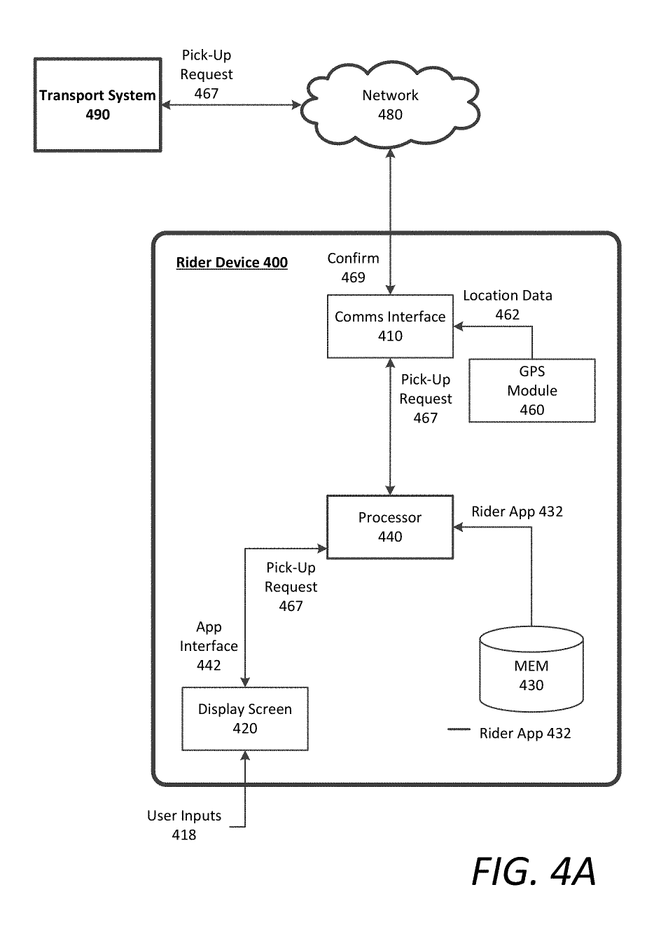

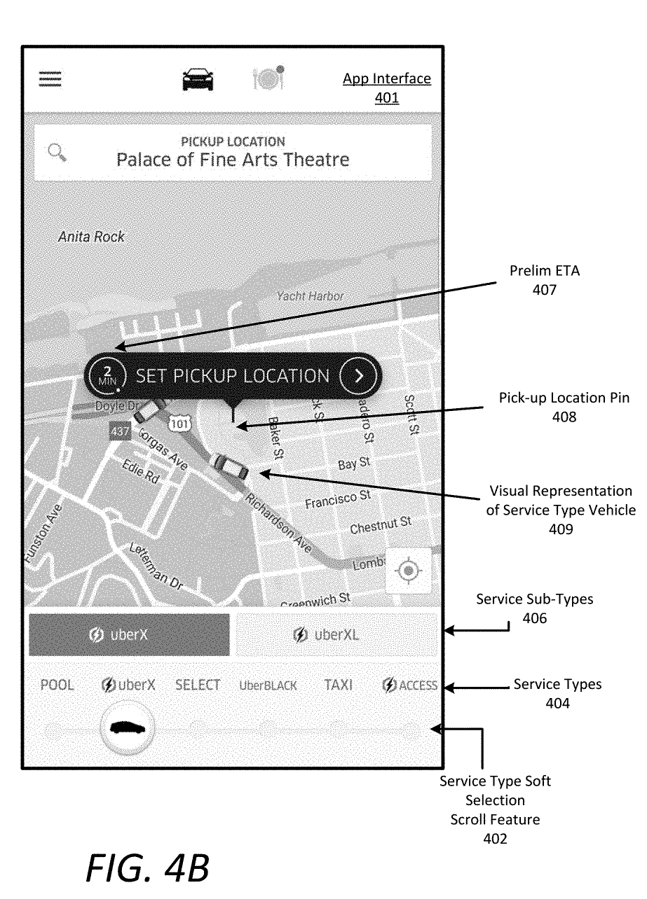

FIG. 4A is a block diagram illustrating an example rider device executing a designated rider application for a transport arrangement service, as described herein. In many implementations, the rider device 400 can comprise a mobile computing device, such as a smartphone, tablet computer, laptop computer, VR or AR headset device, and the like. The rider device 400 can store a designated application (e.g., a rider app 432) in a local memory 430. In response to a user input 418, the rider app 432 can be executed by a processor 440, which can cause an app interface 442 to be generated on a display screen 420 of the rider device 400. The app interface 442 can enable the user to, for example, check current price levels and availability for the transportation arrangement service. In various implementations, the app interface 442 can further enable the user to select from multiple ride service types, such as a carpooling service type, a regular ride-sharing service type, a professional ride service type, a van transport service type, a luxurious ride service type, and the like. Example services that may be browsed and requested can be those services provided by UBER Technologies, Inc. of San Francisco, Calif.

The user can generate a pick-up request 467 via user inputs 418 provided on the app interface 442. For example, the user can select a pick-up location, view the various service types and estimated pricing, and select a particular service for transportation to an inputted destination. In many examples, the user can input the destination prior to pick-up. The processor 440 can transmit the pick-up request 467 via a communications interface 410 to the backend transport facilitation system 490 over a network 480. In response, the rider device 400 can receive a confirmation 469 from the transport facilitation system 490 indicating the selected driver and vehicle that will service the pick-up request 467 and rendezvous with the user at the pick-up location. In various examples, the rider device 400 can further include a GPS module 460, which can provide location data 462 indicating the current location of the requesting user to the transport system 490 to, for example, select an optimal driver or autonomous vehicle to service the pick-up request 467.

FIG. 4B is an example screenshot illustrating a transport service type selection and request screen on a rider device, according to examples described herein. For example, the screenshot shown with respect to FIG. 4B can correspond to a request screen described with respect to the app interface 442 as shown in FIG. 4A. Referring to FIG. 4B, the app interface 401 can include map content and a pick-up location pin 408 that enables the user to set a pick-up location prior to submitting a pick-up request. In setting the location pin 408 on a given point on the map, a preliminary ETA 407 can be displayed for a closest vehicle corresponding to a soft-selected service type 404. As shown, the user can scroll through different service types 404 using a service type soft-selection scroll feature 402. Each soft selection can reset the visual representations of the service type vehicles 409 displayed on the map content based on the actual locations of drivers. In some examples, a service type 404 can include a sub-service type 406. At any given time, the user can provide input to submit a pick-up request to the transport facilitation system 100 described with respect to FIG. 1.

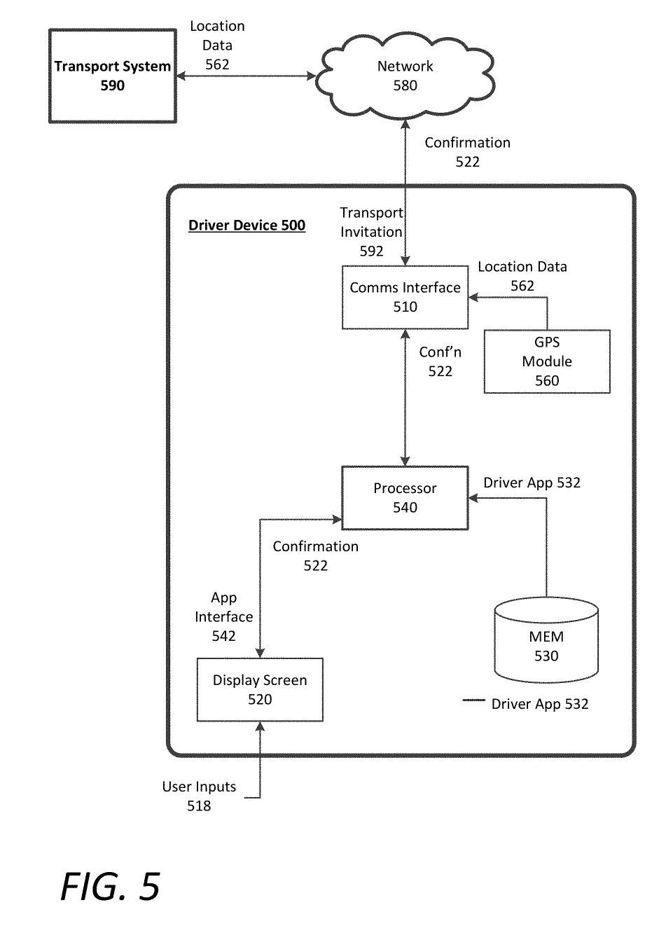

FIG. 5 is a block diagram illustrating an example driver device executing a designated driver application for a transport arrangement service, as described herein. In many implementations, the driver device 500 can comprise a mobile computing device, such as a smartphone, tablet computer, laptop computer, VR or AR headset device, and the like. The drive device 500 can store a designated application (e.g., a driver app 532) in a local memory 530. In response to a user input 518, the driver app 532 can be executed by a processor 540, which can cause an app interface 542 to be generated on a display screen 520 of the driver device 500. The app interface 542 can enable the driver to, for example, accept transport invitations 592 in order to service pick-up requests throughout a given region.

In various examples, the driver device 500 can include a GPS module 560, which can provide location data 562 indicating the current location of the driver to the transport system 590. Thus, the transport system 590 can utilize the location current location driver to determine whether the driver is optimally located to service a particular pick-up request (e.g., based on the driver's future location). If the driver is optimal to service the pick-up request, the transport system 590 can transmit a transport invitation 592 to the driver device 500 over a network 580. The transport invitation 592 can be displayed on the app interface 542, and can be accepted or declined by the driver. If the driver accepts the invitation 592, then the driver can provide a user input 518 on the displayed app interface 542 to provide a confirmation 522 to the transport system 590 indicating that the driver will rendezvous with the requesting user at the pick-up location.

Hardware Diagram

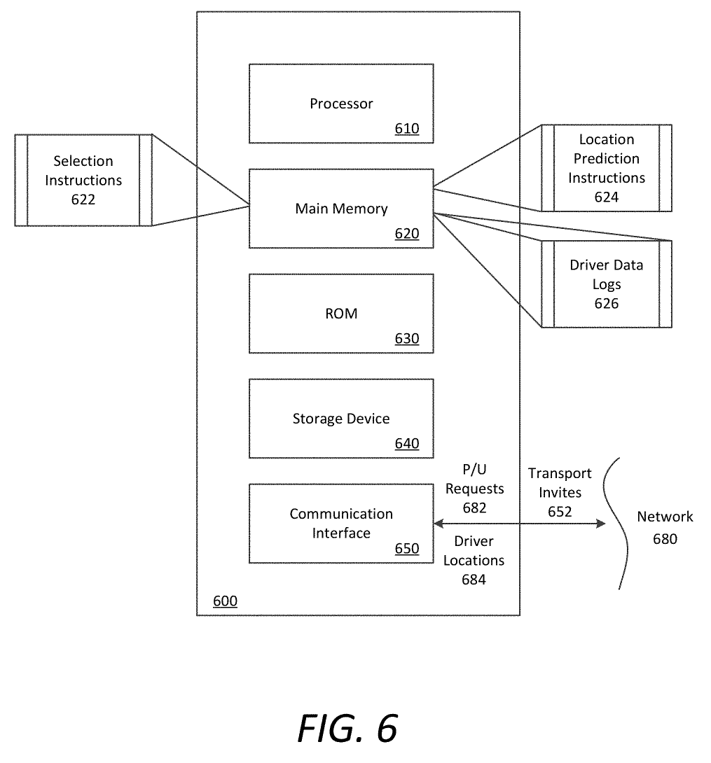

FIG. 6 is a block diagram that illustrates a computer system upon which examples described herein may be implemented. A computer system 600 can be implemented on, for example, a server or combination of servers. For example, the computer system 600 may be implemented as part of a network service for providing transportation services. In the context of FIG. 1, the transport facilitation system 600 may be implemented using a computer system 600 such as described by FIG. 6. The transport facilitation system 100 may also be implemented using a combination of multiple computer systems as described in connection with FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks 680 (e.g., cellular network) through use of the network link (wireless or wired). Using the network link, the computer system 600 can communicate with one or more computing devices, one or more servers, and/or one or more AVs. In accordance with examples, the computer system 600 receives pick-up requests 682 from mobile computing devices of individual users. The executable instructions stored in the memory 630 can include selection instructions 622, which the processor 610 executes to select drivers to service pick-up requests based on pick-up locations and current locations of the drivers. The instructions can further include location prediction instructions 624, which the processor 610 executes to determine future locations of drivers based on the driver locations 684, as described herein.

By way of example, the instructions and data stored in the memory 620 can be executed by the processor 610 to implement an example transport facilitation system 100 of FIG. 1. In performing the operations, the processor 610 can receive pick-up requests 682 and driver locations, predict the future location of the drivers, and generate and transmit transport invitations 652 to service the pick-up requests 682.

The processor 610 is configured with software and/or other logic to perform one or more processes, steps and other functions described with implementations, such as described by FIGS. 1-3, and elsewhere in the present application.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A transport facilitation system comprising:
one or more processors; and
one or more memory resources storing instructions that, when executed by the one or more processors, cause the one or more processors to:
receive current location data from driver devices of drivers operating throughout a given region;
receive a pick-up request from a user device of a requesting user within the given region, the pick-up request including pick-up location data;
determine a plurality of candidate drivers to service the pick-up request based, at least in part, on the pick-up location data and current location data of each of the candidate drivers in the plurality;
predict a future location for each of the plurality of candidate drivers based, at least in part, on map data for the given region;
select a first driver, from the plurality of candidate drivers, to service the pick-up request based, at least in part, on the predicted future locations of the plurality of candidate drivers; and
transmit a transport invitation to a driver device of the first driver to service the pick-up request.

2. The transport facilitation system of claim 1, wherein the executed instructions cause the one or more processors to predict the future location for each respective candidate driver of the plurality of candidate drivers by: (i) determining a direction of travel and speed of the respective candidate driver, and (ii) inputting the predicted future location of the respective candidate driver based on the direction of travel and speed.

3. The transport facilitation system of claim 2, wherein the executed instructions cause the one or more processors to input the predicted future location by (i) utilizing the map data to identify a current road on which the respective candidate driver travels, and (ii) projecting the predicted future location onto the current road.

4. The transport facilitation system of claim 1, wherein the executed instructions further cause the one or more processors to:
identify one or more drivers, in the plurality of candidate drivers, that are currently traveling to an inputted destination; and
utilize the map data to project the future location for the one or more drivers based on a current route being traveled to the inputted destination.

5. The transport facilitation system of claim 1, wherein the executed instructions further cause the one or more processors to:
identify a respective candidate driver, of the plurality of candidate drivers, that is currently traveling on a route having multiple possible paths; and
for each respective path of the multiple possible paths, determine a probability that the respective candidate driver will travel along the respective path;
wherein the predicted future location for the respective candidate driver comprises a location along a highest probable path from the multiple possible paths.

6. The transport facilitation system of claim 5, wherein the executed instructions further cause the one or more processors to:
compile individual driver data indicating common routes traveled for each of the drivers operating throughout the given region;
wherein the executed instructions cause the one or more processors to determine a probability that the respective candidate driver will travel along the respective path by analyzing the individual driver data for routine routes traveled by the respective candidate driver.

7. The transport facilitation system of claim 1, wherein the executed instructions cause the one or more processors to predict the future location for each of the plurality of candidate drivers, select the first driver, and transmit the transport invitation within a typical lag time, the typical lag time corresponding to a time delta between receiving a particular pick-up request, selecting a driver to service the particular pick-up request, and receiving a confirmation from the driver to service the particular pick-up request.

8. The transport facilitation system of claim 7, wherein the predicted future location for each of the plurality of candidate drivers corresponds to the typical lag time.

9. The transport facilitation system of claim 1, wherein the executed instructions comprise shadow mode instructions that, when executed by the one or more processors, cause the one or more processors to:
receive location data indicating current routes of individual drivers operating throughout the given region;
calculate probabilities for future locations of the individual drivers as the individual drivers travel throughout the given region;
determine outcomes of the calculated probabilities; and
construct and bolster location prediction models based on the outcomes of the calculated probabilities;
wherein the executed instructions cause the one or more processors to predict the future location for each of the plurality of candidate drivers by utilizing the location prediction models constructed via execution of the shadow mode instructions.

10. A non-transitory computer-readable medium storing instructions that, when executed by one or more processors, cause the one or more processors to:
receive current location data from driver devices of drivers operating throughout a given region;
receive a pick-up request from a user device of a requesting user within the given region, the pick-up request including pick-up location data;
determine a plurality of candidate drivers to service the pick-up request based, at least in part, on the pick-up location data and current location data of each of the candidate drivers in the plurality;
predict a future location for each of the plurality of candidate drivers based, at least in part, on map data for the given region;
select an first driver, from the plurality of candidate drivers, to service the pick-up request based, at least in part, on the predicted future locations of the plurality of candidate drivers; and
transmit a transport invitation to a driver device of the first driver to service the pick-up request.

11. The non-transitory computer-readable medium of claim 10, wherein the executed instructions cause the one or more processors to predict the future location for each respective candidate driver of the plurality of candidate drivers by: (i) determining a direction of travel and speed of the respective candidate driver, and (ii) inputting the predicted future location of the respective candidate driver based on the direction of travel and speed.

12. The non-transitory computer-readable medium of claim 11, wherein the executed instructions cause the one or more processors to input the predicted future location by (i) utilizing the map data to identify a current road on which the respective candidate driver travels, and (ii) projecting the predicted future location onto the current road.

13. The non-transitory computer-readable medium of claim 10, wherein the executed instructions further cause the one or more processors to:
identify one or more drivers, in the plurality of candidate drivers, that are currently traveling to an inputted destination; and
utilize the map data to project the future location for the one or more drivers based on a current route being traveled to the inputted destination.

14. The non-transitory computer-readable medium of claim 10, wherein the executed instructions further cause the one or more processors to:
identify a respective candidate driver, of the plurality of candidate drivers, that is currently traveling on a route having multiple possible paths; and
for each respective path of the multiple possible paths, determine a probability that the respective candidate driver will travel along the respective path;
wherein the predicted future location for the respective candidate driver comprises a location along a highest probable path from the multiple possible paths.

15. The non-transitory computer-readable medium of claim 14, wherein the executed instructions further cause the one or more processors to:
compile individual driver data indicating common routes traveled for each of the drivers operating throughout the given region;
wherein the executed instructions cause the one or more processors to determine a probability that the respective candidate driver will travel along the respective path by analyzing the individual driver data for routine routes traveled by the respective candidate driver.

16. The non-transitory computer-readable medium of claim 10, wherein the executed instructions cause the one or more processors to predict the future location for each of the plurality of candidate drivers, select the first driver, and transmit the transport invitation within a typical lag time, the typical lag time corresponding to a time delta between receiving a particular pick-up request, selecting a driver to service the particular pick-up request, and receiving a confirmation from the driver to service the particular pick-up request.

17. The non-transitory computer-readable medium of claim 16, wherein the predicted future location for each of the plurality of candidate drivers corresponds to the typical lag time.

18. The non-transitory computer-readable medium of claim 10, wherein the executed instructions comprise shadow mode instructions that, when executed by the one or more processors, cause the one or more processors to:
receive location data indicating current routes of individual drivers operating throughout the given region;
calculate probabilities for future locations of the individual drivers as the individual drivers travel throughout the given region;
determine outcomes of the calculated probabilities; and
construct and bolster location prediction models based on the outcomes of the calculated probabilities;
wherein the executed instructions cause the one or more processors to predict the future location for each of the plurality of candidate drivers by utilizing the location prediction models constructed via execution of the shadow mode instructions.

19. A computer-implemented method of location prediction and driver selection in connection with a transportation arrangement service, the method being performed by one or more processors and comprising:
receiving current location data from driver devices of drivers operating throughout a given region;
receiving a pick-up request from a user device of a requesting user within the given region, the pick-up request including pick-up location data;
determining a plurality of candidate drivers to service the pick-up request based, at least in part, on the pick-up location data and current location data of each of the candidate drivers in the plurality;
predicting a future location for each of the plurality of candidate drivers based, at least in part, on map data for the given region;
selecting an first driver, from the plurality of candidate drivers, to service the pick-up request based on the predicted future locations of the plurality of candidate drivers; and
transmitting a transport invitation to a driver device of the first driver to service the pick-up request.

20. The computer-implemented method of claim 19, wherein the executed instructions cause the one or more processors to predict the future location for each respective candidate driver of the plurality of candidate drivers by: (i) determining a direction of travel and speed of the respective candidate driver, and (ii) inputting the predicted future location of the respective candidate driver based on the direction of travel and speed.
